(19) United States
(12) Patent Application Publication
(10) Pub. No.: US 2005/0038721 A1
(43) Pub. Date: Feb. 17, 2005

(54) Integrated utility accounting, materials management, work management and regulatory reporting software

(75) Inventors: Chris Goeckel, Duluth, GA (US); Tom E. Wheeler, Marietta, GA (US)

Correspondence Address: ALSTON & BIRD LLP;BANK OF AMERICA PLAZA, 101 SOUTH TRYON STREET, SUITE 4000, CHARLOTTE, NC, 28280-4000, US

(73) Assignee: WebSourceIT, LLC

(21) Appl. No.: 10/638,877

(22) Filed: Aug. 11, 2003

(51) Int. Cl. G06F 17/60

(52) U.S. Cl. 705/30

(57) ABSTRACT

The invention is an integrated software system that provides one set of books for work management, accounting and regulatory reporting functions. The account structure of the general ledger is shared across the various entities (or departments) of the utility such that they all record the same information about activities, transactions and balances, thus sharing the same ledger structure comprised of a very limited number of segments, generally five to seven. The segments form an account flexfield. Certain segments of the account flexfield, if not supplied, may be derived from the other segments. The system is based on commercially available database software and allows for single ledger entries that are integrated throughout the accounting and reporting system of the utility. Account flexfields are entered into the system at a certain level of detail, such as, for example, activity, work order, natural account and regulatory account levels and may be summarized at a level of detail other than the one entered. The system provides reports in either an accounting format (financial and managerial) or in the form required by regulatory bodies without having to re-enter or reconcile data or keep separate sets of books.

### BACKGROUND OF THE INVENTION

1. Field of the Invention

The invention relates to computer software and, in particular, computer software for accounting applications, specifically those tailored for utilities.

2. Description of Related Art

In addition to general financial accounting reports as may be required by the Securities and Exchange Commission (SEC), the Internal Revenue Service (IRS), Secretary of State, etc., regulated entities such as utilities (e.g., electric, gas, water, telecommunications, sewer, etc.) may have several additional layers of reporting. For example, a utility may be required to produce financial (and operational) reporting information for the Federal Communications Commission (FCC), the Federal Energy Regulatory Commission (FERC), the Nuclear Regulatory Commission (NRC), the various states' Public Utility Commissions (PUCs), and for any number of other federal, state or local regulatory agencies or commissions. These reports vary greatly from the Generally Accepted Accounting Principles (GAAP) used to produce financial and managerial accounting reports for external (and internal) use. Additionally, these regulatory reports may vary greatly between regulating bodies.

Previously, many utilities have kept separate sets of “books” in order to meet the mandatory reporting requirements. However, this has resulted in the need for duplicitous accounting entries (thus, additional labor), additional accounting personnel and systems, and tedious reconciliation between the various sets of books. Some utilities have attempted to operate their business from only one set of books in order to avoid the “multiple books” problem. However, if the utility operates with only the regulatory books, utility management's strategic decision making is hampered by the difficulty of creating meaningful managerial accounting reports. Likewise, if only GAAP books are kept, the utility may have to manually create the regulatory reports in an intensive, time-consuming endeavor. Also, some companies have attempted to keep a single primary set of books and a set of separate adjustments to get from the primary set of books to the secondary set(s) of books. This also results in a problem coordinating the transactions and requires multiple adjustment entries to be coordinated among the various sets of books, thereby creating a maintenance and reconciliation problem. Furthermore, most utilities have separate independent systems for work management, materials management, accounting and regulatory reporting. These separate systems are typically designed for the specific user requirements and require detailed knowledge of each discipline in order to interact effectively with the respective system. This also results in the duplication of entries for the same activity and the potential for entry errors. In yet other instances where the utility has attempted to keep a single set of books for managerial reporting, public reporting and regulatory reporting by using separate code block segments for each reporting level, they have had to code each entry for the number of possible report levels, thus making the entering of transactions into their accounting system cumbersome and difficult to use, especially for non-accounting field users of the systems. This typically results in designing the system to accommodate the field users, thus making it more difficult for financial, managerial and accounting users to get meaningful data from the system effectively. Alternatively, the typical system is designed to accommodate the financial, managerial, and accounting users, thus requiring field users to memorize complex and unintuitive account strings to properly record transactions. This results in field users' frustration with the system, creation of “side systems” to attempt to track operational data, and overall poor quality of data input from the field since the field users are not skilled in the details and nuances of financial accounting theory.

Companies desire to manage their businesses using a particular set of accounts to reflect the results of operations of their respective businesses in a way to facilitate making better business decisions over time as the result of study, use and analysis of such information. These particular accounts are often referred to as the “chart of accounts.”Accounting events occurring during a time period (generally, a fiscal year) are entered and kept in a general ledger. The accounts that comprise the chart of accounts form the basis for identifying discrete accounting events within the general ledger.

Some companies are required to report on their operations to multiple governing bodies as a result of various promulgated rules. Many of these companies are publicly held entities requiring reporting of operations to be based on GAAP rules for SEC reporting. These same companies may also have particular reporting needs internally imposed by management in order to facilitate effective and efficient company operations and governance. Further, these entities may be required to report to various regulatory bodies in a way consistent with the reporting formats promulgated by these various governing bodies such as the FCC, FERC, NRC and/or state (PUC) regulatory bodies or any number of others.

Therefore, to overcome the challenges associated with the need for multiple reporting requirements and having separate, independent operational and accounting systems, and to facilitate the intuitive, stream-lined and meaningful entry of transactions, the inventive concepts of the embodiments of the present invention were developed.

### BRIEF SUMMARY OF THE INVENTION

The embodiments of the invention are integrated software systems that provide one set of books for work management, materials management, accounting and regulatory reporting functions. The account structure of the general ledger is shared across the various entities (and/or departments) of the utility; they all record the same information about activities, transactions and balances, thus sharing the same ledger structure comprised of a very limited number of segments, generally five to seven. Much of the information they will need to input into the system is automatically defaulted into the fields available for them to input information. This keeps the field users from needing to know the details of the accounting theory and insulates them from account coding confusion. These defaults may be overridden if, for example, the employee worked outside their area or for a different department, etc. By utilizing various validation routines both within and outside of Enterprise Resource Planning (ERP) systems that comprise embodiments of the invention, the appropriate level of input data can be pre-selected and presented to the users of the system. For example, a user in the accounting department will be able to interact with an embodiment of the system of the invention using the natural and regulatory account segments, while an operations field worker will be able to work with an embodiment of the system using the activities such person will be performing while confusing accounting data will be hidden from such user's view, but supported in the background via the relationships between activities and accounts. This allows each user to interact with the system in a more intuitive manner, much as they consider their work tasks on a day-to-day basis. Generally, entries to the system are made at the lowest level in the organization (as close to the actual work) as possible to avoid errors.

Embodiments of the system utilize the basic data structures of ERP systems such as, for example, Oracle™ database software as is available from the Oracle Corporation, Redwood City, Calif.; PeopleSoft™ software as is available from PeopleSoft, Inc, Pleasanton, Calif.; SAP™ software as is available from SAP AG, Newtown Square, Pa. (U.S. headquarters); and software from J.D. Edwards, Denver, Colo.; Lawson Software, St. Paul, Minn.; GEAC Computer Corporation Ltd., Ontario, Canada and other software vendors. The embodiments of the invention allow for single entries into ledgers that are integrated throughout the accounting and reporting system of the utility. The embodiments provide for ledger entries that are “coded” to certain segments including, for example, company, line of business, department, and the geographical unit. In some instances, the entry may include the natural (or GAAP) account and the regulatory account will be derived from the other “coded” segments. In other instances the entry may include the regulatory account and the natural account will be derived from the other “coded” segments. Natural or GAAP accounts are those that are normally found on financial reporting statements such as an income statement or a balance sheet. They may be specific to the business and have several levels. For example, a GAAP account of “line maintenance” may roll up to a parent account of “distribution maintenance expenses” which then rolls up to a parent of “maintenance expenses.” The regulatory account(s) are accounts that are used for reporting to regulatory agencies such as, for example, FCC, PUC, FERC, NRC, etc. As provided above, predefined relationships within an embodiment of the system of the invention may cause the regulatory account of an entry to be derived from the coded information of the ledger entry. Embodiments of the system also allow the use of one or more additional ledger coding segments, usually simply known as “future,” which may be specifically tailored to the particular utility.

Embodiments of the invention provide several reporting levels for maintenance activities that may be classified as “Regulatory Account Level,” “Activity Level” and “Natural Account Level.” For capital projects and optionally, operations and maintenance (O&M) projects, the “Work Order” level is an additional level of detail maintained in addition to those identified above. The work order, specific materials and other detailed charges can be identified from transaction detail created and maintained in the sub-ledgers and summarized and passed into the general ledger. For example, a maintenance worker for an electric utility may report two activities during a day's work, replacing distribution cutouts and removing vegetation from the lines. When these events are entered at the Activity Level of an embodiment of the system, the ledger segments company, line of business, department, geographical unit and natural account are related to the person doing the work and where it was done, so they are known. The appropriate regulatory account is derived from the information entered. For example, the appropriate FERC account for the two above-mentioned activities may be “571—Maintenance of Overhead Lines.” However, rolling both of these activities into the same GAAP account (e.g. “line maintenance”) may not be satisfactory for managerial decision making purposes. Therefore, the replacement of cutouts may go into a “distribution line maintenance” (GAAP) account and the vegetation clearing may go into a “vegetation clearing” (GAAP) account. The vegetation clearing GAAP account may also roll up to a higher-level parent GAAP account called “tree trimming and vegetation removal.” The utility's management is then able to intelligently and accurately track the utility's expenditures for activities such as tree trimming and vegetation removal.

Embodiments of the invention allow entries to be posted only once whereby entries may be posted at various levels and may be reported/summarized at other levels. For instance, entries may be posted in a sub-ledger at the “Activity Level,” yet rolled up and reported/summarized at the “Regulatory Account” and “Natural Account” levels, as well as at the “Activity Level.” Likewise, entries may be posted at the “Regulatory Account” level and broken down by predefined relationships within the system and reported/summarized at the “Activity Level,” or they may be converted by predefined relationships and reported/summarized at their “Natural Account Level” (i.e., GAAP). Also, entries may be posted at their “Natural Account” level and the report/summary of the “Activity Level” of the entries may be derived, as well as the report/summary of the “Regulatory Level.” Capital projects and optionally O&M projects add the additional reporting/summary level (and posting level) of Work Order depending on management desire or preference.

A utility may be subject to more than one regulatory reporting requirement. For instance, an electric utility may be required to report to the FERC as well as one or more state PUCs. The detail or reporting requirements may vary among these regulatory reports. Therefore, the “Regulatory Account” level may actually involve more than one reporting/summary level. However, as described above, entries made at the Activity, Natural Account, (or Work Order) level can be reported and summarized at each of the particular Regulatory Account levels. In the example above, entries made to the Activity, Natural Account and Work Order level may be separately summarized in one report for the FERC and in another report for the state PUC. Likewise, entries posted at any of the Regulatory Account levels may be reported/summarized at the Activity, Natural Account and/or Work Order levels.

The invention may be specifically tailored to the utility using the system; however, the basic functionality of the invention is transportable across all types (e.g., electric, gas, telecommunications, water, sewer, etc.) of utilities. It is equally applicable to all forms of utilities or entities that have reporting requirements in addition to the GAAP reports.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 is a diagrammatic representation of an exemplary integrated utility work management, accounting and regulatory reporting system in an embodiment of the invention;

FIG. 2A is an exemplary representation of the structure of the segments that comprise an account flexfield in an embodiment of the invention;

FIG. 2B is an exemplary representation of the structure of the segments that comprise an account flexfield and illustrates deriving one segment from the other known segments in an embodiment of the invention;

FIG. 2C is an exemplary data entry screen illustrating the entry of an accounting event into a ledger or sub-ledger and the account flexfield associated with that accounting event in an embodiment of the invention;

FIG. 3 is an exemplary data screen illustrating information about an employee that may be utilized by an embodiment of the invention;

FIG. 4 is an illustrative representation that information posted at one level of detail may be summarized at one or more other levels of detail in an embodiment of the invention;

FIG. 5A is an illustrative representation of the ability of an embodiment of the invention to receive postings to the general ledger at a first level of detail and to summarize and report on such postings at a second level of detail that may differ from the first level of detail;

FIG. 5B is an illustrative representation of the ability of an embodiment of the invention to receive postings to the general ledger at an activity level of detail and to summarize and report on such postings at the activity, natural account, regulatory account and work order levels of detail;

FIG. 5C is an illustrative representation of the ability of an embodiment of the invention to receive postings to the general ledger at a natural account level of detail and to summarize and report on such postings at the activity, natural account, regulatory account and work order levels of detail;

FIG. 5D is an illustrative representation of the ability of an embodiment of the invention to receive postings to the general ledger at a regulatory account level of detail and to summarize and report on such postings at the activity, natural account, regulatory account and work order levels of detail;

FIG. 5E is an illustrative representation of the ability of an embodiment of the invention to receive postings to the general ledger at a work order level of detail and to summarize and report on such postings at the activity, natural account, regulatory account and work order levels of detail;

FIG. 6 is an illustrative representation of the account hierarchy and allocation process that exists for certain flexfield accounts and allows entries at any point in the hierarchy to either be rolled up to a higher summary level or drilled down into its more basic levels (such as work orders and activities) in an embodiment of the invention;

FIG. 7 is an illustrative representation of summaries that may be generated for each child within a block code segment (parent), which may be cumulatively or selectively rolled up within a block code segment, or they may be combined with other summarized “children” across segments for reporting purposes in an embodiment of the invention; and

FIG. 8 is a graphical representation of the relationships that exist between sub-ledgers, the general ledger, parents and children of the general ledger, and reporting features of an embodiment of the invention.

### DETAILED DESCRIPTION OF THE INVENTION

The present inventions now will be described more fully hereinafter with reference to the accompanying drawings, in which some, but not all embodiments of the invention are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

The present invention is described below with reference to block diagrams and flowchart illustrations of methods, apparatuses (i.e., systems) and computer program products according to an embodiment of the invention. It will be understood that each block of the block diagrams and flowchart illustrations, and combinations of blocks in the block diagrams and flowchart illustrations, respectively, can be implemented by computer program instructions. These computer program instructions may be loaded onto a general purpose computer, special purpose computer, or other programmable data processing apparatus to produce a machine, such that the instructions that execute on the computer or other programmable data processing apparatus create means for implementing the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including instruction means that implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Accordingly, blocks of the block diagrams and flowchart illustrations support combinations of means for performing the specified functions, combinations of steps for performing the specified functions and program instruction means for performing the specified functions. It will also be understood that each block of the block diagrams and flowchart illustrations, and combinations of blocks in the block diagrams and flowchart illustrations, can be implemented by special purpose hardware-based computer systems that perform the specified functions or steps, or combinations of special purpose hardware and computer instructions.

The embodiments of the invention are generally comprised of a software system running on one or more processors with devices for receiving information into the system and viewing or otherwise outputting the information or reports on the information. The system, both hardware and software, may be distributed in that the processors as well as the input and output devices are not required to be centralized at one location. The system software in one embodiment is based on Oracle™ software, although software available from other vendors such as PeopleSoft™, SAP™, Lawson™, JD Edwards™, GEAC™ etc., or software that is developed independently may be used.

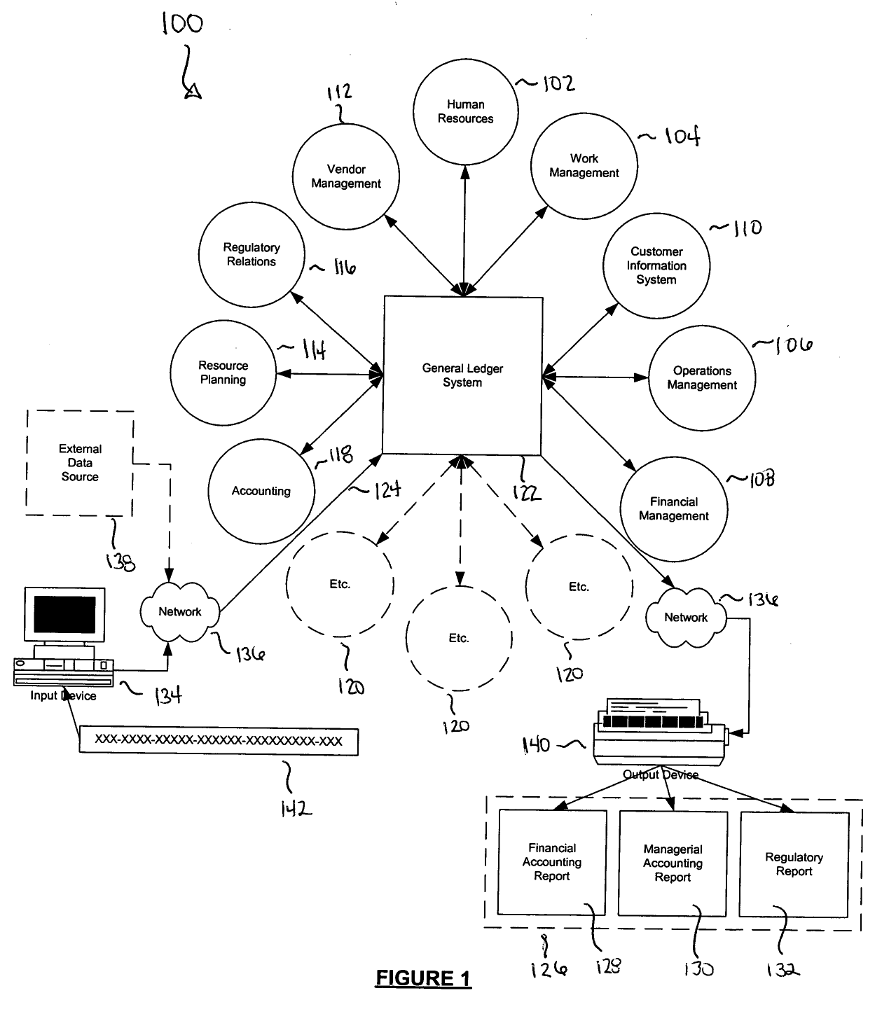

FIG. 1 is a diagrammatic representation of an exemplary integrated utility accounting, materials management, work management, and regulatory reporting system in an embodiment of the invention. The system illustrated in FIG. 1 is generally implemented by computer program instructions stored on a media such as, for example, computer-readable memory, running on a general-purpose computer, special purpose computer or other programmable data-processing apparatus. As illustrated in FIG. 1, the system of this embodiment of the invention 100 integrates the accounting, operations and reporting functions of a utility. Such disparate functions as, for example, human resources 102, work management 104, operations management 106, financial management and billing 108, customer information management 110, vendor management 112, resource planning 114, regulatory management 116, accounting 118, and others 120 are integrated with a general ledger system 122 such that they all share a common set of segments of information 142. This information may be input directly 124 into the general ledger system 122 or it may be obtained from sub-ledger systems (not shown), interface tables (not shown), or other data repositories 102, 104, 106, 108, 110, 112, 114, 116, 118, 120. For example, existing customer information databases 110 may be used to populate a sub-ledger or an interface table in the proper format for entering information into the general ledger system 122. The system 100 is capable of reporting functions 126 in formats satisfactory for financial 128 and managerial 130 accounting reports as well as reports for regulatory bodies 132 without having to manually re-enter, consolidate or otherwise “massage” data or keep separate “books” for accounting and regulatory reporting requirements. Exemplary reports that may be created by embodiments of the invention are attached as Appendices A, B and C. Appendix A and Appendix B are financial reports 128. Appendix A is a balance sheet for an exemplary utility, while Appendix B is an income statement. Appendix C is an example of a regulatory report 132, and is a FERC report. Each of these appendices are fully incorporated herein and made a part hereof.

As described above, the integrated utility functions (e.g., human resources 102, work management 104, etc.) may exist as separate pre-existing or stand-alone systems where data is extracted and formatted into a sub-ledger or interface table that is then imported into the general ledger system 122, or these systems may be fully integrated into the general ledger system 122 such that information is input and kept as sub-ledgers of the general ledger system 122, thereby providing a high degree of flexibility and adaptability to the system 100 of the invention. Generally, a separate sub-ledger or interface table exists for each integrated utility function from which information is imported into the general ledger system 122. An interface table is generally used to format data from a pre-existing system (e.g., a pre-existing human resources 102 system) into a format that is compatible with the general ledger system 122. A sub-ledger may exist as an integrated utility function that is provided as a module of the general ledger system 122, or it may exist as a stand-alone system that is integrated with the general ledger system 122.

Devices 134 used to enter information into the general ledger system 122 or any of the sub-ledgers or interface tables include any form of wired, optical or wireless data entry device such as, for example, a computer terminal, a numeric or alphanumeric keypad, a data entry terminal, a bar code scanner, an optical scanner, a magnetic card reader, a radio frequency identification (RFID) tag, a personal digital assistant (PDA), etc. Data may also be routed through a network 136 to the general ledger system 122 or any of the sub-ledgers of the integrated system from automated devices or sources external 138 to the system 122 such as, for example, global positioning satellite (GPS) information, time clocks, currency conversion programs, Internet search engines, Internet web sites, etc. Such a network 136 may be wired, wireless or optical and may involve protocols such as that used by, for example, the Internet. Output devices 140 include printers, displays, or any other means of visualizing the information. Such devices may be connected to the system 100 by a network 136.

The embodiments of the present invention 100 provide for development of an account code structure (including code block segments and child segment levels) 142, a set of allocation methodologies for the allocation of accounting events to their natural and regulatory accounts, recurring journal entries and derived code block segments (derived from the values provided from the other code block segments for the same accounting entry) to facilitate entities required to report to multiple reporting entities (for example: FERC, FCC, PUC, SEC, internal management and stockholders). This structure allows the embodiments of the system to interact with the various sub-ledgers and the general ledger 122 using a single and simplified coding structure while allowing the system 100 to utilize defaults, allocations, recurring journal entries and other code block segment values to derive the remaining code block segments required in order to facilitate all of the required reporting out of a single set of accounting books while still maintaining a simplified and compact accounting code block 142 with a relatively few number of segments.

The system 100 is centered about a general ledger 122. Entries may be made directly to the general ledger 122 or they may be received electronically into the general ledger 122 from one or more sub-ledgers or interface tables. Each entry into the general ledger 122, whether directly or through a sub-ledger, is comprised of a number of code block segments 142 that taken together form a journal entry. Each code block segment (parent) is limited to a certain number of values (children), as such values are determined by the application of the system 100 at a specific utility. The code block segments 142 form a chart of accounts for the general ledger 122 of the utility.

The chart of accounts is established through a process of assigning user defined values for the various code block segments 142 of the chart of accounts. For example, the following is an exemplary illustration of how a typical utility might set-up the code block segments 142 of Company, Line of Business, Department, Location, Natural Account, Regulatory Account, and Future Use:

Company—Identifies the company structure necessary to appropriately manage the business of one or more companies.

Line of Business—Identifies the individual unique lines of business, products and services to be tracked in the system.

Department—Identifies the list of individual unique department, cost center, profit center or other user defined segmentation cuts of the business.

Location or Geographical Unit—Identifies the unique physical location of items at a level of detail necessary to manage the business revenues, expenses, track assets and liabilities by location. This may be done with a location ID or via the use of x and y coordinates to identify locations or by the use of Global Positioning System (GPS) location codes.

Natural Account—These are income, expense, asset, liability and equity accounts necessary to effectively manage the business from a financial and operational perspective.

Regulatory Account—These are accounts necessary to effectively report to various local, state, and/or federal regulators.

Future Use—There may be one or more additional segments added to allow for changing needs of information over time as the requirements for operating and managing the various businesses change.

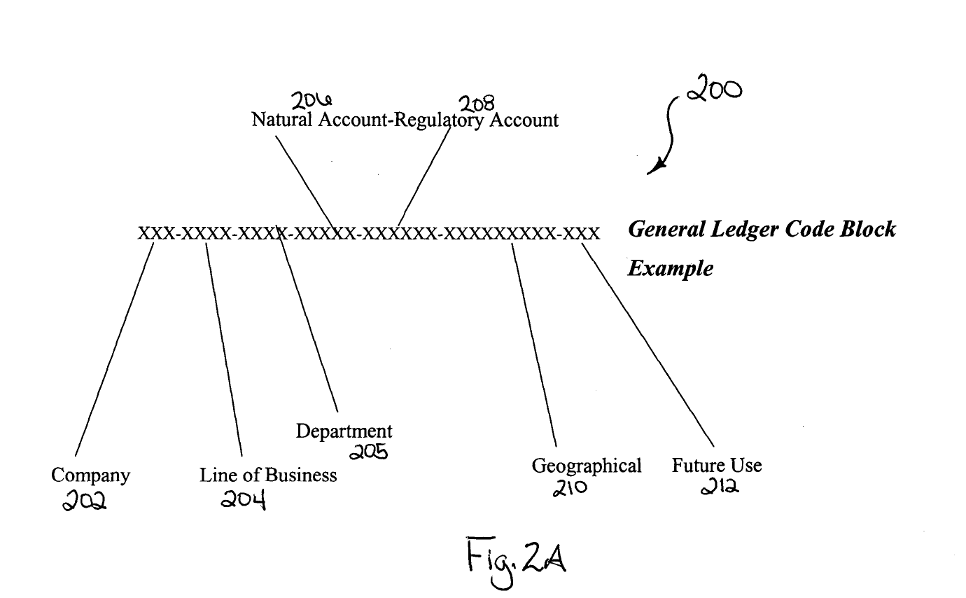

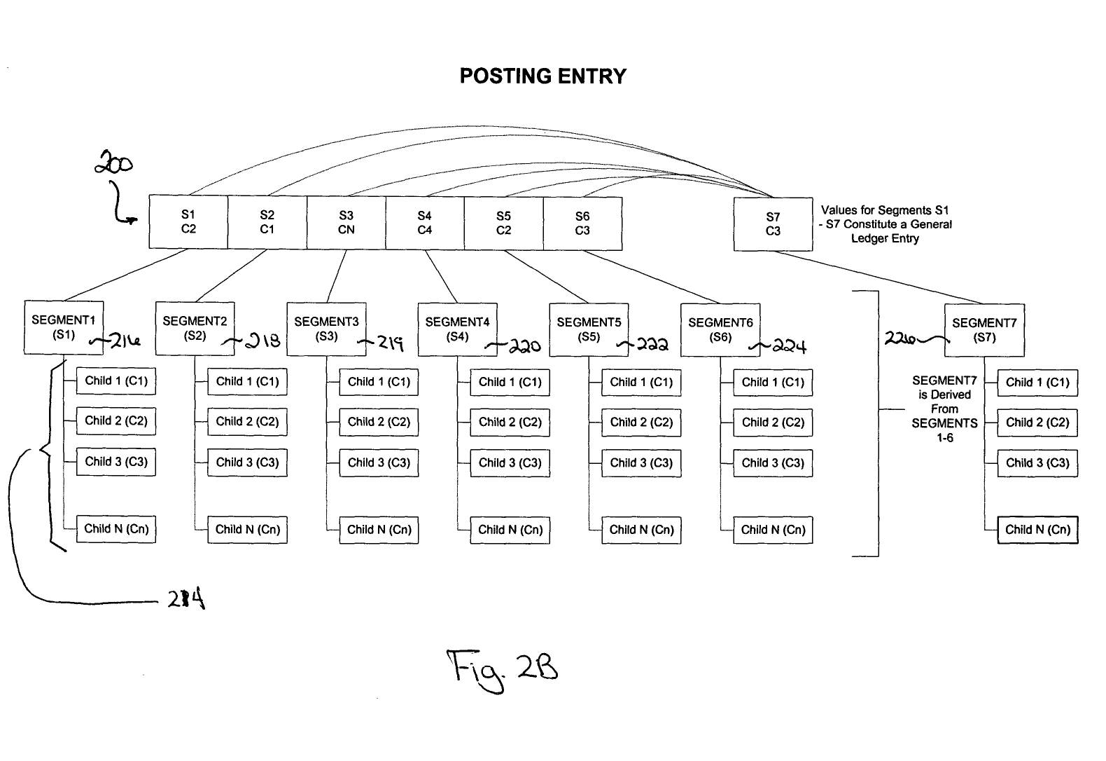

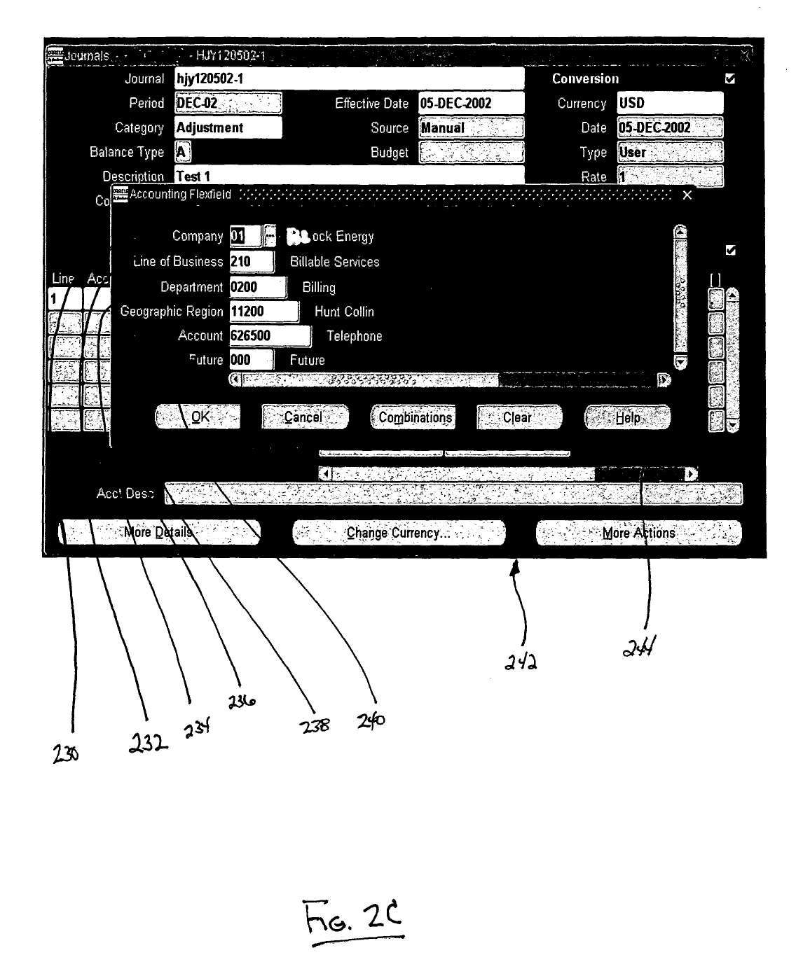

The general ledger 122 of the embodiments of the invention 100 is designed such that one account flexfield structure can be shared among all departments of an organization and among all entities of an organization comprised of one or more legal entities (a “multi-entitied organization”). The account flexfield in embodiments of the invention is comprised of a number of code block segments 142 (generally, between five and seven, may also include a “future use segment.”) FIGS. 2A and 2B are illustrative of the structure of an exemplary account flexfield. The account flexfield 200 of the embodiment of FIG. 2A is comprised of seven code block segments, namely company 202, line of business 204, department 205, natural account 206, regulatory account 208, geographical 210, and future use 212.

FIG. 2C is an exemplary data entry screen illustrating the entry of an accounting event and the account flexfield 200 associated with that event in an embodiment of the invention. This particular exemplary account flexfield 200 is comprised of the code block segments: company 230, line of business 232, department 234, geographic region 236, regulatory account 238, and future 240. In FIG. 2C, an accounting event entry screen 242 is shown in the background, while an account flexfield entry screen 244 is shown in the foreground. A person is able to enter the information about the accounting event and then complete the entry of the account flexfield 200 that is associated with that accounting event in this manner. In other embodiments, account flexfield 200 information may be assigned to one or more events that are imported into the general ledger from a sub-ledger, spreadsheet, or interface table.

As previously provided, these code block segments 142 define the chart of accounts for the general ledger 100. The definition or name of each code block segment 142 represents the elements of the business structure (now and anticipated) that are considered important by the business's management and that will make up the general ledger 122 account code. This particular account flexfield 200 (of FIG. 2A) is comprised of seven code block segments 142, company 202, line of business 204, department 205, natural account 206, regulatory account 208, geographical unit 210 and future use 212. Each code block segment 202, 204, 205, 206, 208, 210, 212 is assigned one or more values known as “child segment values.” As shown in FIG. 2B, a single list of child segment values within each segment is applicable for all entities of a multi-entitied organization. The child segment value accounts for the lowest level of detail required for posting and reporting in the general ledger. The child segment value can be entered directly into the general ledger by a user, derived from a source document, exist within a sub-ledger or can be logically mapped to attributes that exist at the transaction interface whereby if certain other code block segments are given certain child segment values, then one or more other child segment values will receive a “default” value. Budgeting and control functions and limitations may be imposed at the child segment value, or the direct parent segment value as a next-level-up in the reporting structure. The code block segments are arranged in a specific sequence to form an account flexfield 200 structure; therefore, their sequence of entry from an entry perspective is important.

Referring to FIG. 2A, the seven code block segments of this exemplary account flexfield 200; company 202, line of business 204, department 205, natural account 206, regulatory account 208, geographical 210, and future use 212, can be referred to as segments S1, S2, S3, S4, S5, S6 and S7, respectively. Each of these segments (S1 through S7) will have children 214 with values C1 through Cn, depending upon the defined code block segment that serves as the parent and the structure of the utility. An accounting hierarchy exists within the general ledger 122. A child 214 to parent relationship exists and is always defined within a particular code block segment 142 where the child 214 is the child segment value and the parent is the code block segment. Referring to FIG. 2B for instance, the segment S1 218 (or if thought of as “company” 202) has the children C1 through Cn 214. C1 through Cn 214 may include for example a holding company (e.g., HoldCo), and wholly-owned subsidiaries such as, for example, a telecommunications subsidiary (TelComSub), an electric distribution company (DisCo), an electric transmission company (TransCo), an electric generation company (GenCo), a service company (ServCo), etc. One or more of these entities may or may not be regulated, depending upon the regulatory laws applicable to the organization.

A child 214 cannot cross reference to child segment values or code blocks in other segments. The child 214 to parent relationship is comprised of two levels, an entry level (child) and a summary level (parent or grandparent). The summary level represents a range of children (or parent) accounts where the relationships are fixed and histories with transaction balances are not recalculated when organizational changes are made. In organizations undergoing dynamic change, the parent-child structure remains flat (i.e., there is no hierarchical relationships—only an entry level exists) until parent-child relationships become are established or stays flat if many organizational changes are expected. The parent to child association establishes the relationships between accounts from a roll-up or drill-down perspective. The relationship also limits the combination of account combinations (parent and child) to limit data entry mistakes because a certain child will only roll-up to a specific parent or parent account. Allocations of expenses and revenues are also determined by the parent-child relationship. The parent to child relationship of the general ledger 122 is used for: budget control purposes; on-line inquiry; account management; posting and query privileges; formulas (allocations); drill-down in the general ledger; and sub-ledger connection points (interfaces validate against a child's parent and post to the child value at all times).

When establishing the parent to child relationships, the child segment values 214 are first determined. The child segment value 214 is the entry level journal or transaction import) and should be logical to the end-user (or interface program), but also not too detailed so as to burden the ledger. The child segment value 214 should represent the lowest level of transaction detail in the general ledger 122 through drill-down on balances, if the user requires more detail, the child segment value 214 should be the natural intersection point or highest level of summary to the sub-system (or accounts payable/accounts receivable sub-ledger). The parent value is the intersection point for the reporting (roll-up) structure.

A second step in establishing parent-child relationships is to determine the budgeting method and decide if budget control will be implemented. Encumbrance accounting and fund checking can be implemented at the parent-child relationship level. Encumbrance accounting and fund checking include concepts whereby a utility may be partially or wholly government owned or government controlled. In such instances, funds or accounts within the chart of accounts are encumbered for purposes of distributing funds for a specific purpose (i.e., a form of governmental control). Additionally, even if there are no governmental influences, accounts may be controlled by budgetary constraints whereby they are not allowed to exceed the budgeted or allocated amount for a given fiscal calendar period.

Fund checking is accomplished in embodiments of the invention that allow the user to see funds expended to date for an account or project and materials purchased (but not delivered or received) and planned work that may have not been posted to the general ledger, thus allowing the user to determine the remaining amount of available funds for the account or project. As an example of the parent-child relationship, and as previously described, a parent may be the code block segment “company” and “children” associated with that “parent” may include, for example, the holding company HoldCo, and its wholly owned subsidiaries TelComSub, DisCo, TransCo, ServCo and GenCo. For the code block segment “line of business” (parent), the children may be, for example, transmission, distribution, wireless, retail, wholesale, etc. At least one child is defined for each of the code block segments that comprise an account flexfield 200.

The account flexfield structure 200, as shown in FIGS. 2A and 2B, is generally comprised of: the number of segments (elements of business structure) that make up the general ledger account code; the name; and the order (sequence) of entry. The sequence becomes important when accounting posting rules are implemented in the sub-ledgers (accounts payable and accounts receivable) to define the “default-to” flexfield value set. This is because code block segments are validated as they are entered and if certain programmed rules are satisfied as the code block segments are validated, other remaining code block segments may have a “default” value automatically entered by the general ledger system. For example, the accounting flexfield 200 for a particular utility in an exemplary embodiment of the invention may be comprised of the code block segments: company, line of business, natural (or GAAP) account, regulatory account, geographical unit and future use, with the accounting flexfield 200 having the sequence of the segments as indicated. Therefore, when posting from a sub-ledger, an interim step may be used to place the information into a format useable by the account flexfield structure 200. Such an interim step may involve the us of an interface table.

Referring now primarily to FIG. 2B, the account flexfield 200 of this embodiment is comprised of seven code block segments S1 216, S2 218, S3 219, S4 220, S5 222, S6 224 and S7 226. Each of these segments, S1 216 through S7 226, is constrained to a limited number of allowable values, with each of these allowable values being a child 214 of its respective parent code block segment. Furthermore, one or more of these code block segments 216, 218, 219, 220, 222, 224, 226 may be derived by the system 100 from the values assigned to the other code block segments. For example, as shown in FIG. 2B, the value of S7 226 is derived from the values of the code block segments S1 216, S2 218, S3, 219, S4 220, S5 222, and S6 224. In this particular instance, S1 216 has been given the value of its child C2, S2 218 has been given the value of its child C1, S3 219 has been given the value of its child Cn, S4 220 has been given the value of its child C4, S5 222 has been given the value of its child C2, and S6 224 has been given the value of its child C3. From the values given to S1 216 through S6 224, the system 100 is able to determine the value of S7 226, which in this particular illustrative example is the value of S7's 228 child, C3.

In embodiments of the invention involving multi-entitied organizations, the accounting calendar, chart of accounts, and currency of all reporting entities must agree as to the year-end date, base currency and number of accounting periods. The sub-ledgers (accounts payable, accounts receivable) contain the detailed transactions and may be shared or segregated by the main operating units (parent company and the consolidated subs) and may have currencies other than the base currency (so long as the currencies are converted to the common currency used by the general ledger when the sub-ledger information is brought into the general ledger) and do not have to have the same accounts within the master (general ledger) account (i.e., can vary as long as there are defined relationships between the various unique accounts); however the parent company and subs may still share a common customer/vendor database.

Generally, in the embodiments of this invention, a single set of books is used for all the departments of an organization and all the entities of a multi-entitied organization. The account flexfield structure is shared across all the various departments or entities—they all record the same information about transactions and balances, thus sharing the same five to seven segment structure. All the entities (of a multi-entitied organization), have the same accounting calendars—fiscal or calendar year defining the year-end date and periods on a weekly (or monthly) processing cycle; however, they all do not have to initiate transactions in the same functional currency. The software system provides for sharing of a single operating unit by all the entities of a multi-entitied organization. Entities share the same operating unit, for example, where resources (inventory, warehouses and people) are shared across an organization's boundaries. If not shared, a multi-entitied setup allows the ability to segregate transactions in the sub-ledger (accounts receivable and accounts payable) on the condition they still share the same single set of books (typical scenario for consolidated subsidiaries).

Accounting transactions may be posted to the general ledger system 122 at various levels according to the invention. In one embodiment, when posting at the “natural account” 206 level, the entered accounting flexfield 200 includes only the code block segments of the natural (or GAAP) account 206, company 202, line of business 204, department 205, geographical 210 and future use segments 212. An embodiment of the software system of the invention 100 derives the regulatory account 208 from the entered segments such that the complete accounting flexfield 200 is comprised of the company 202, line of business 204, department 205, natural account 206, regulatory account 208, geographical unit 210, and future use 212 segments, in that sequence, and as such concept is illustrated in FIG. 2B. One or more of the entered segments such as, for example, the “future value” 212 may be a default value. In another embodiment, when posting to the general ledger system 122 at the “regulatory account” 208 level, the entered account flexfield 200 includes the regulatory account 208 code block segment for the entry, as well as the code block segments; company 202, line of business 204, department 205, geographical 210 and future use 212 segments. The software system of the embodiments of the invention 100 derive the natural (or GAAP) account 206 from the entered segments such that the complete accounting flexfield 200 is comprised of the company 202, line of business 204, department 205, natural account 206, regulatory account 208, geographical unit 210, and future use segments 212, in that sequence, as also illustrated in FIG. 2B. The account flexfield 200 of the embodiments of the system 100 is designed such that sufficient information is contained within the other code block segments of the account flexfield 200 that either the natural account 206 or the regulatory account 208 (but not both), may be omitted from an account flexfield 200 entry and the system 100 will determine the proper natural account 206 or regulatory account 208, respectively, from the information contained within the other code block segments of the account flexfield 200. This is accomplished through the use of cross-validation rules and security checks that are coded into the software of the system so that when sufficient account flexfield 200 information is entered, as described above, the remaining un-entered values will be determined by cross-validation rules and security checks coded into the general ledger system and utilizing validation tables.

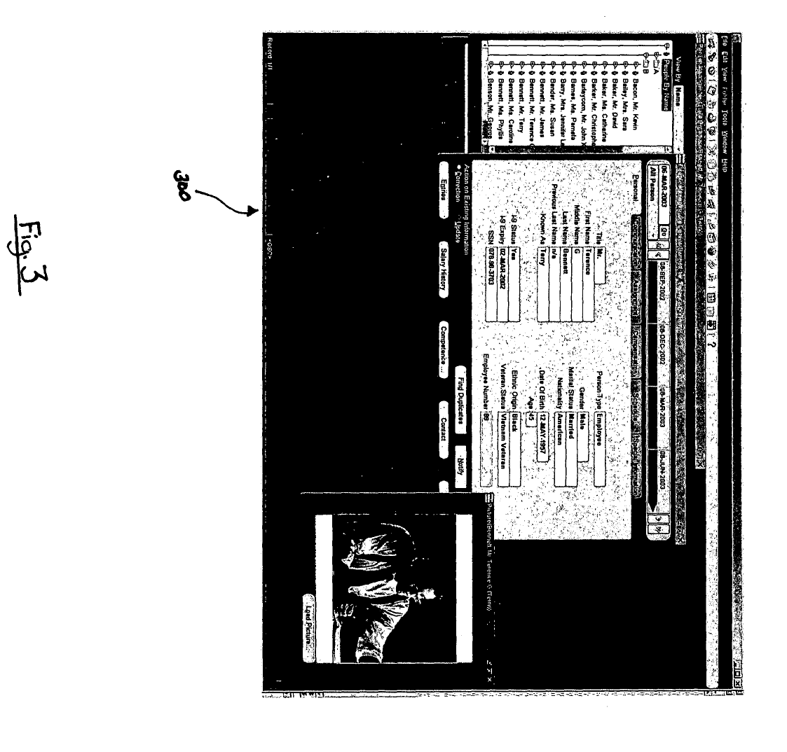

Account flexfield 200 information may also be entered into one or more sub-ledgers at, for example, an activity level. For instance, when an employee such as a technician is entering a time sheet, the employee's logging on to the software system of the invention will allow the software to confirm the employee's access authorization to the system as well as to verify and retrieve employment information from either a separate human resources (HR) system or an HR system that is a part of the software of the invention that resides as one or more sub-ledgers. The HR information will supply the employee's company, line of business, geography, department and other “static” information. FIG. 3 is an illustrative exemplary screen 300 showing information that is available from an HR system about a typical employee in an embodiment of the invention. The system illustrated in FIG. 3 may be a part of a separate HR system or may be an HR system that is incorporated into an embodiment the system of the invention. The employee will be associated within the software of an embodiment of the invention with a group of activities to which that employee may selectively choose to charge time and/or expenses. The employee will choose an activity, generally from a drop-down menu available through the system at the data entry interface, and enter the number of hours or the expense associated with that selected activity. The employee's pay rate will be available in the HR information and any hours of labor entered will be converted to a currency figure. This information may be stored in a sub-ledger such as, for example, a payroll sub-ledger. The activities that may be chosen by the employee are mapped to natural (GAAP) accounts, which are cross-referenced to regulatory accounts. Each employee is defined to the system by organization, line of business (by type or function such as, for example, lineman, accountant, etc.), department, geography, and job level. As provided above and as illustrated in FIG. 3, this information may reside in a separate HR system or may be incorporated as a sub-ledger of an embodiment of the present invention. System access (security) rules determine what accounts the user has authority to post transactions. In this manner, each time entry is associated with all the information that comprises an account flexfield 200 for that entry. Additionally, accounts are mapped to the specific activities that can be performed and posted to the account(s). Therefore, when entering activity-level information into the system of an embodiment of the invention, an employee only sees activities that they are responsible for performing or activities for which they may enter time, materials or expenses. However, the system is flexible enough so that work may be performed by an employee in areas outside of their “pre-defined” organization, department or line of business outside of their base areas by use of a manual override. Such overrides, in an embodiment of the invention, may require authorization from a supervisor or other personnel designated by the system for override authority. When these manual override events occur, in an embodiment of the invention the activity to account relationship remains the same based on the predefined mapping. This feature facilitates utility outage situations or when an employee “covers” for another absent employee. Therefore, all the account flexfield 200 information is available from the HR sub-ledger, the information entered by the employee, the natural account mapping and the cross-referenced regulatory accounts such that an interface table or sub-ledger may be populated with sufficient information to comprise the account flexfield 200 for each entry and then the information is imported into the general ledger.

In other instances, the employee may perform work that is associated with one or more work orders that are sub-tasks of one or more projects. Work orders are generally developed for capital projects, but may also be associated with maintenance items. Numerous work orders may be associated with a single project. Work orders (and projects) are mapped to natural accounts that, in turn, are cross-referenced to regulatory accounts. Similar to the selection of activities as previously described when entering information into the system, an employee will be associated via a table with a group of work orders. The employee will select a work order from a drop-down menu that shows the work orders associated with that employee to charge time or expenses. An employee may also charge time and expenses to a work order not listed (an override), if such an override is properly authorized. If time is charged to a work order, then hourly rate information from the HR sub-ledger will be used to convert the time entry into currency. This information may also be stored in a sub-ledger such as the payroll sub-ledger previously described. Therefore, all the account flexfield information is available from the HR sub-ledger, the information entered by the employee, the natural account mapping and the cross-referenced regulatory accounts such that an interface table may be populated and then the information is imported into the general ledger.

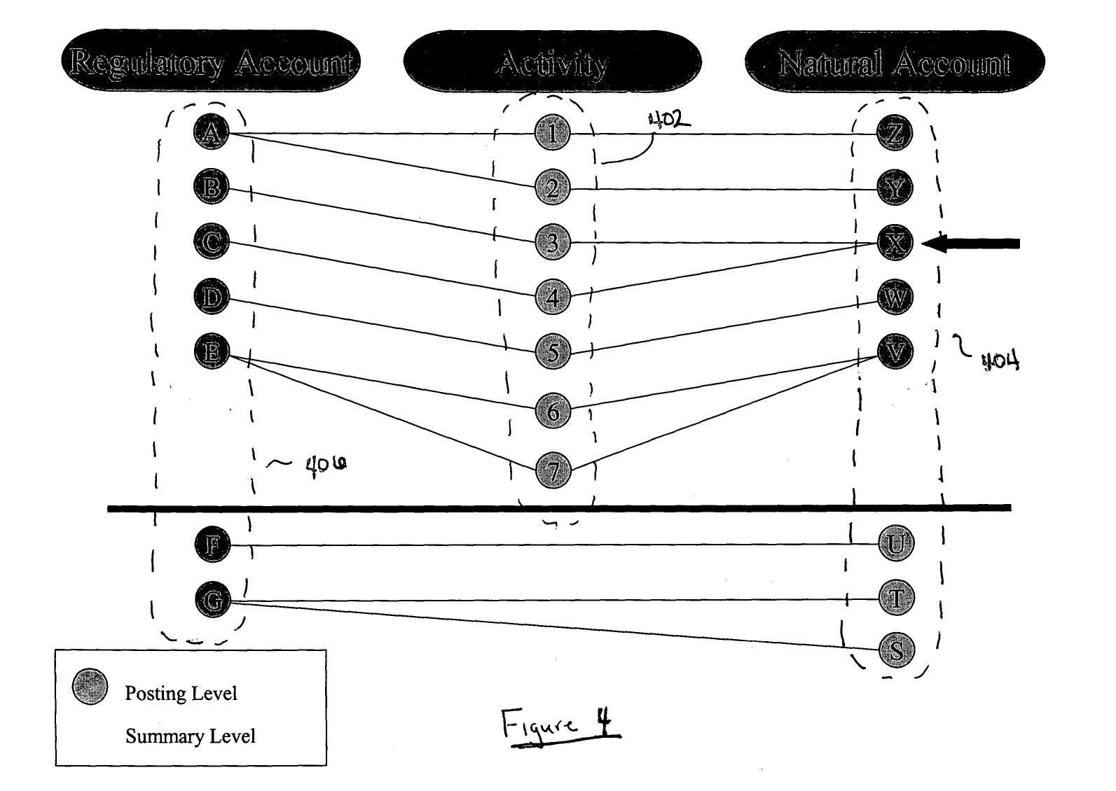

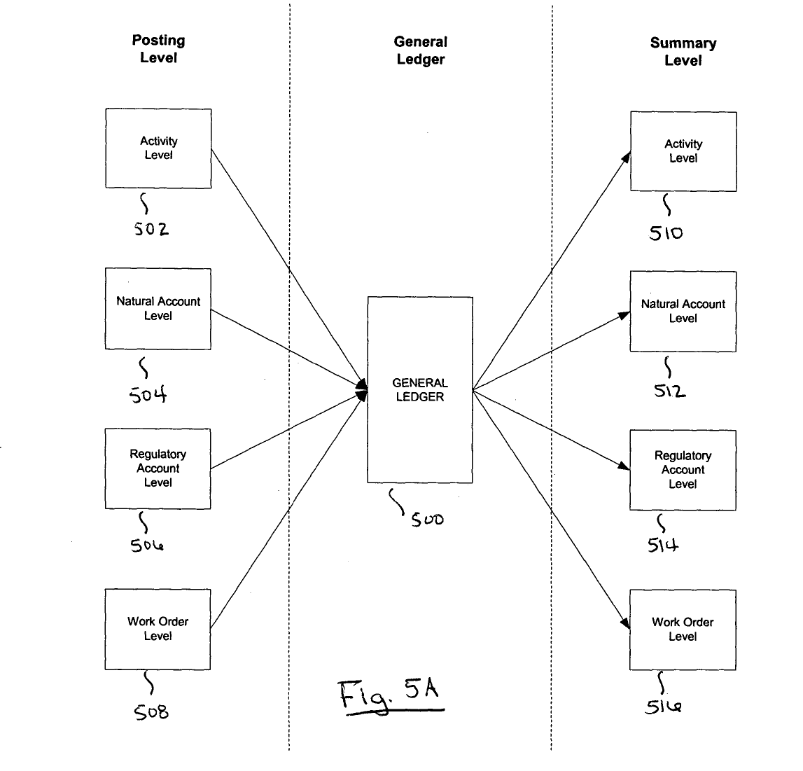

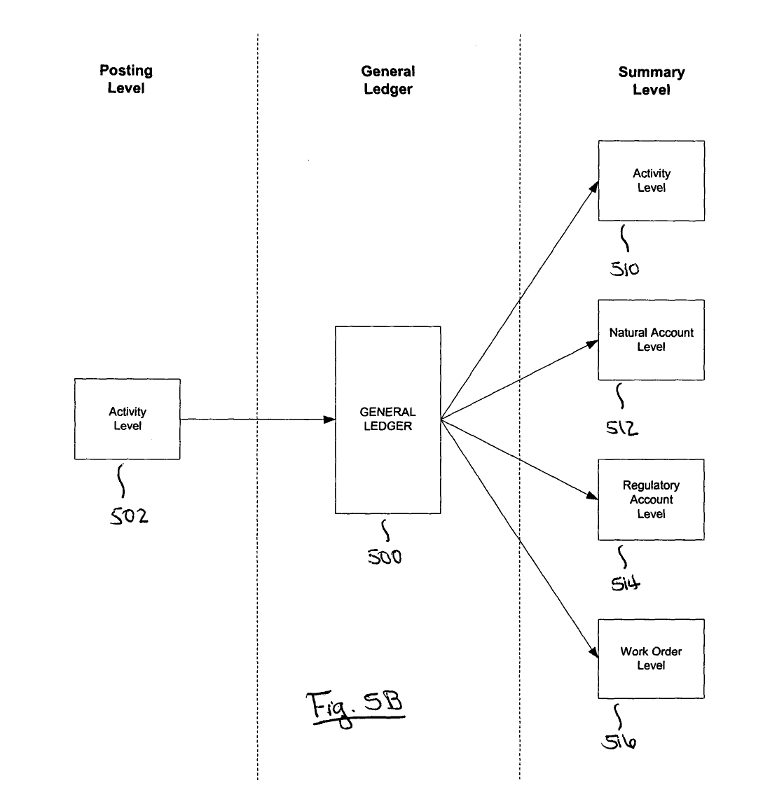

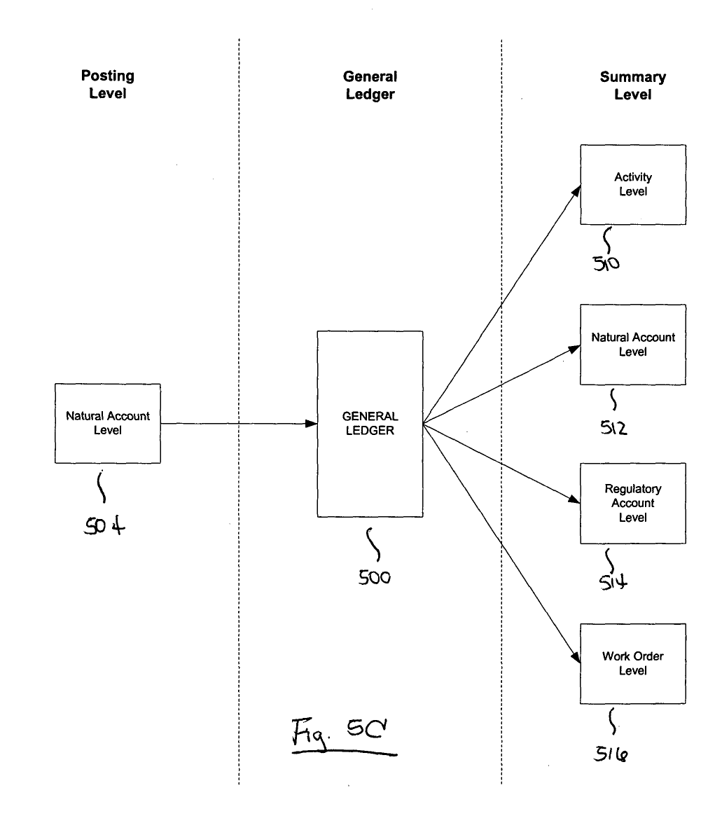

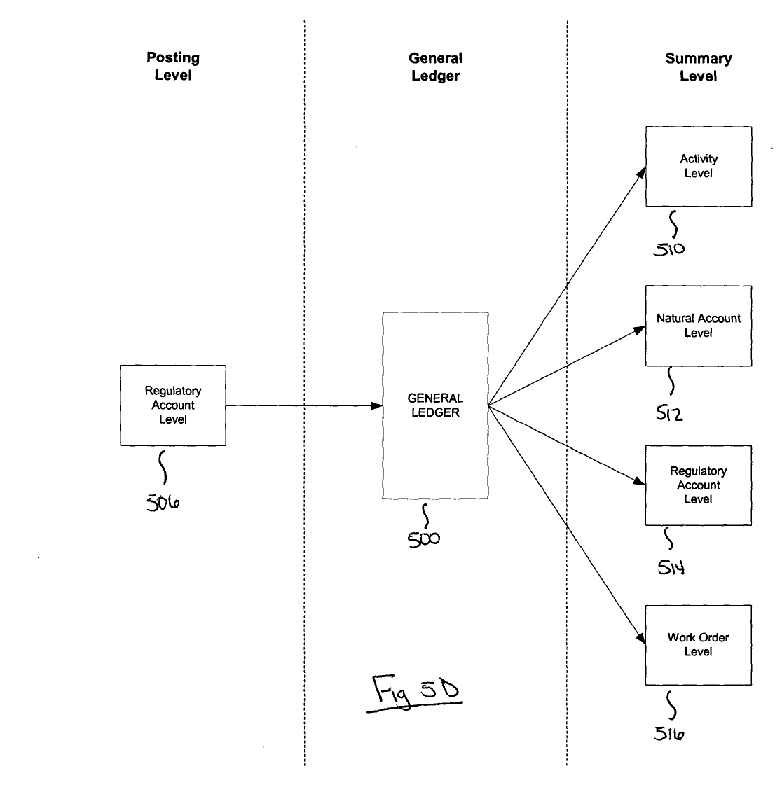

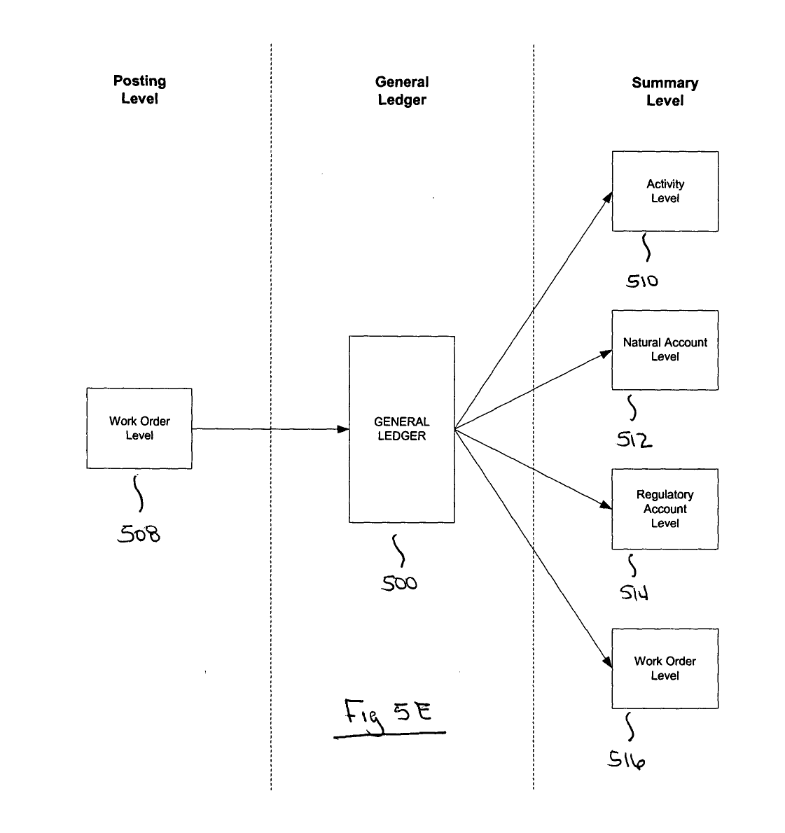

Because of the common form of the account flexfield 200 that is used to post entries to the system 100 of the invention, entries posted at one level may be used to report at other levels. As shown in FIG. 4, entries posted at the activity level 402 may be aggregated to form summary reports at one or more levels such as natural account 404 and regulatory account 406. There is not necessarily a one-to-one relationship between activity postings 402 and natural accounts 404 or regulatory accounts 406. Likewise, postings at either the natural account 404 level or the regulatory account 406 level may be reported at the activity 402 levels, and postings at the natural account level 404 may be reported at the regulatory level 406 and postings at the regulatory level 406 may be reported at the natural account 404 level. This ability to report on various levels from an account flexfield 200 entry is further illustrated in FIGS. 5A through 5E. FIG. 5A illustrates the ability to post to the general ledger 500 at the activity 502, natural account 504, regulatory account 506 and work order 508 levels and to report from such postings at one or more of the activity 510, natural account 512, regulatory account 514, and work order levels 516. FIG. 5B illustrates the ability in an embodiment of the invention to receive as an input one or more entries posted at the activity level 502 and the ability of the invention to summarize and report on such entries at one or more of the activity 510, natural account 512, regulatory account 514, and work order levels 516. FIG. 5C illustrates the ability in an embodiment of the invention to receive as an input one or more entries posted at the natural account level 504 and the ability of the invention to summarize and report on such entries at one or more of the activity 510, natural account 512, regulatory account 514, and work order levels 516. FIG. 5D illustrates the ability in an embodiment of the invention to receive as an input one or more entries posted at the regulatory account level 506 and the ability of the invention to summarize and report on such entries at one or more of the activity 510, natural account 512, regulatory account 514, and work order levels 516. FIG. 5E illustrates the ability in an embodiment of the invention to receive as an input one or more entries posted at the work order level 508 and the ability of the invention to summarize and report on such entries at one or more of the activity 510, natural account 512, regulatory account 514, and work order levels 516.

Embodiments of the present invention allow entries that are posted at the activity 502 and/or the work order 508 level to be summarized at the natural account 512 or regulatory 514 level; likewise, entries posted at the regulatory account 514 level may be summarized at the natural account 512 level, the work order 516 level, or the activity level 510; and entries posted at the natural account 504 level may be summarized at their regulatory account 514, work order 516 and activity 510 levels. This is because the software system allows each entry, whether it is at the natural account 504, regulatory account 506, work order 508 or activity level 502, to have a hierarchy that associates its entry level to the desired reporting level. This hierarchy is established through the use of cross-validation rules that are developed during the configuration process of the system. The cross-validation defines the relationships between the account code segments of the chart of accounts. A user of the system is granted access authority upon logging in to the system whereby such access allows the user certain permissions to enter information and prepare reports.

If an organization is comprised of more than on legal entity, the organization may “share” employees between entities. In such instances of shared employees, a sub-ledger or interface table will exist for each employee for each legal entity that indicates the activities and work orders to which the employee may charge time and expenses. These activities and work orders are mapped to natural accounts that are cross-referenced to regulatory accounts, as previously described. Employees are assigned to a primary organization (home cost center) in the HR system (reference FIG. 3). In many instances; however, there may be several entities that comprise the organization for which the employee may perform work. In such instances, the employee may perform work for entities other than the home cost center. When an employee performs work for an entity other than their home cost center, their time and materials (i.e., costs) are assigned to the entity for which the work is performed. The employee's home cost center receives relief from the employee's salary, overheads and other costs for the work performed.

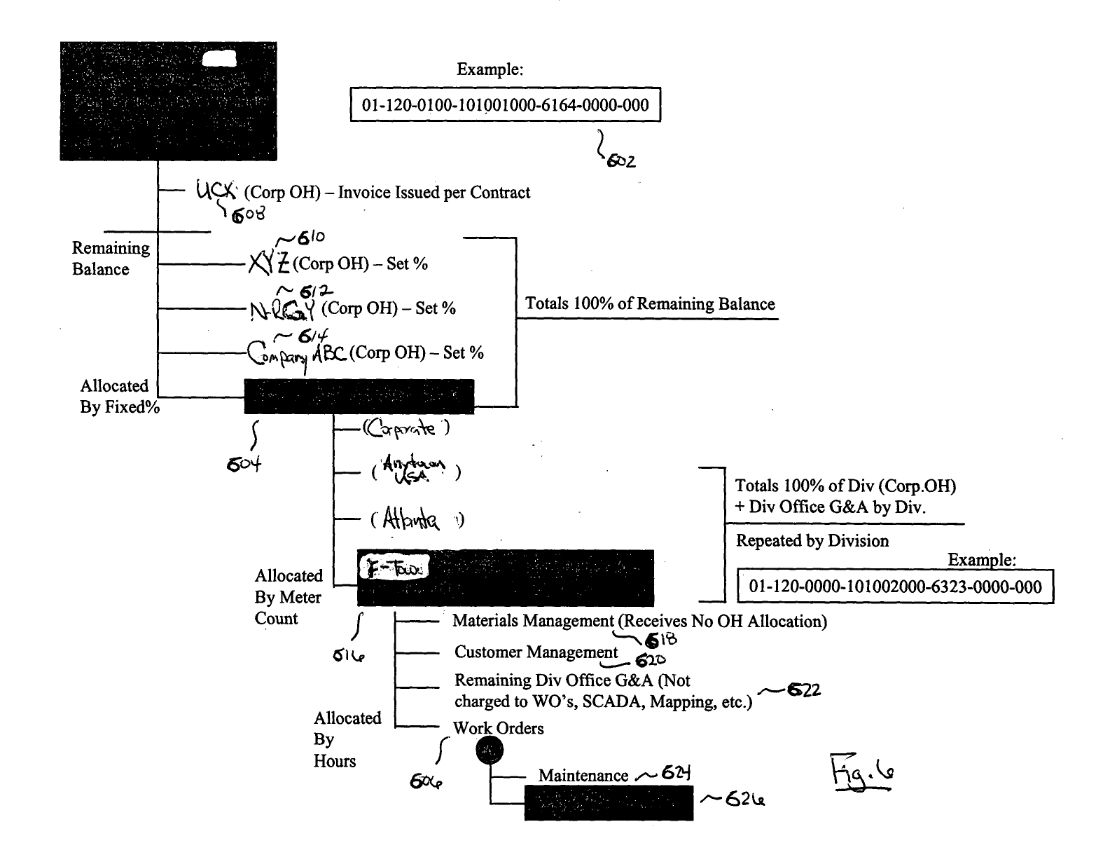

As shown in FIG. 6, an account hierarchy exists for certain account flexfields whereby the entered account flexfield 602 may be associated with segments for, for example, divisions 604, that are in turn associated with segments for work orders 606. Such a hierarchy may exist for natural accounts such as, for example, overhead expenses, or it may exist for a regulatory account such as, for example, expenses associated with a rate case before a PUC. A template of such allocations exists for each natural account or regulatory account level entry that is allocable. This hierarchical relationship allows entries at any point in the hierarchy to either be rolled up to a higher summary level or drilled down into its more basic elements (such as work orders and activities). For example, and as shown in FIG. 6, a corporate overhead (natural account) flexfield 602 account entry may be allocated, depending upon the natural account code block specified, to one or more child segment values of one or more other code block segments as determined by predefined relationships within the software system of the invention that are established for each utility. As shown in exemplary FIG. 6, a certain amount is allocated to the parent company's corporate overhead (a natural account) 608. Depending upon the natural account code block segment used and the structure of the software system for that utility, the overhead may be allocated among subsidiary entities 610, 612 of the parent 608 as well as one or more divisions 614, 604 of the parent 608 or a subsidiary entity. In the exemplary embodiment of FIG. 6, a certain fixed percentage of this amount is allocated to each of the child segment values of a code block segment known as “divisions” 604. If an amount has been allocated to a particular division 616, then the software system will allocate the amount that has been allocated to that division 616 to the locations within that division 616 based on the meter count of the locations. Within each location 618, 620, 622 that has received an allocation, the software system will distribute that allocation to the designated departments within that division. Furthermore, a certain amount of the allocation to the location will be distributed to designated work orders (either maintenance and/or capital work orders) 606 within that location depending upon the natural account code block segment specified. Finally, an embodiment of the software system is capable of distributing the amount that is allocated to a work order 606 to the activities 624, 626 that are associated with that work order 606. These predefined relationships (and their hierarchy) is developed specifically for each utility and the account flexfields of that utility and allows the utility to report at various levels including natural account, regulatory account, department, geography, line of business, work order and activity level from entries made at only the natural account level. This is accomplished by a process of defining the organizational hierarchy within the system of the invention and by the cross-validation rules between segments within the chart of accounts.

Similarly, a regulatory account entry (e.g., an entry allocated to a FERC account), although not shown in FIG. 6, can likewise be allocated throughout that entry's hierarchy as such hierarchy is established within the software system. Likewise, this is accomplished by a process of defining the organizational hierarchy within the system of the invention and by the cross-validation rules between segments within the chart of accounts and with specific activities mapped to individuals and groups of accounts.

Reporting (Roll-Up): Summary Level Within And Across Segments

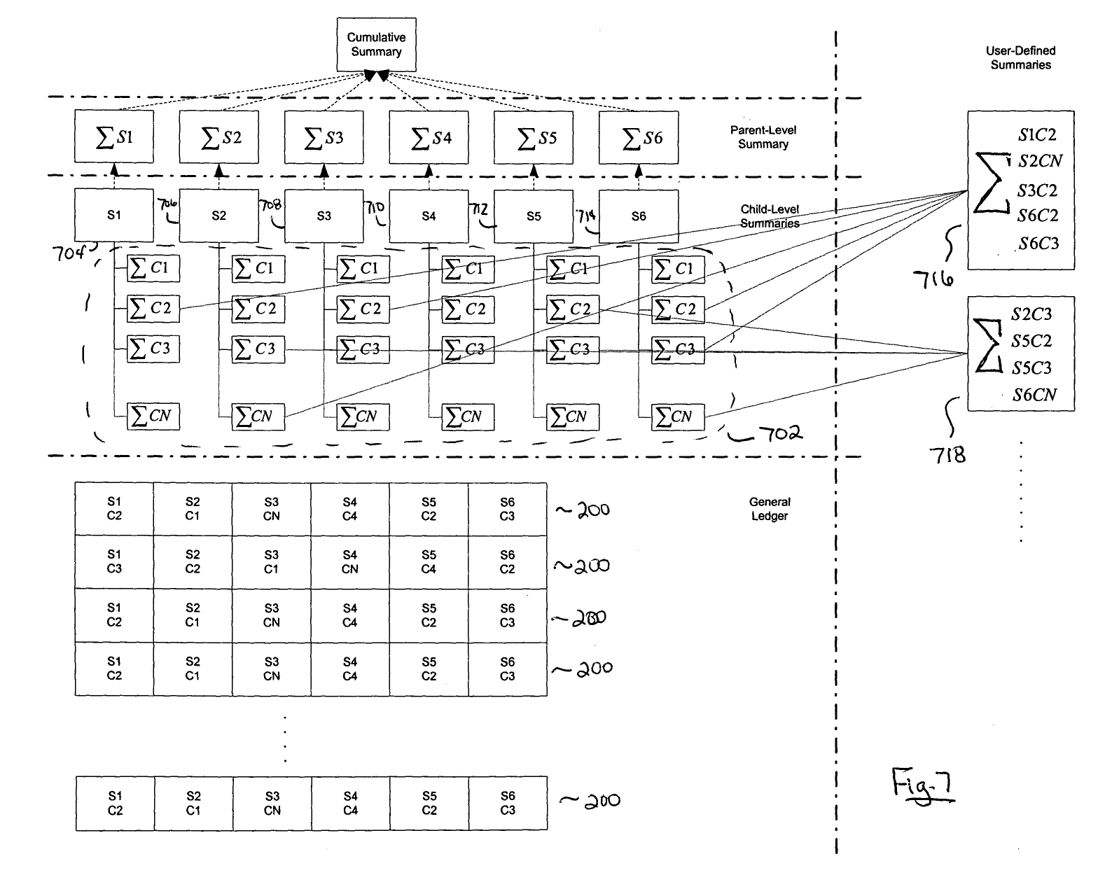

As shown in FIG. 7, summaries 702 may be generated for each child (C1 through Cn) within a block code segment (parent), shown in FIG. 7 as S1 704, S2 706, S3 708, S4 710, S5 712, and S6 714. These child summaries 702 may be cumulatively or selectively rolled up within a block code segment (S1 through S6), they may be combined with other summarized “children” across segments 716, 718, or child segment values may be selectively chosen to create a summary level. Such summaries 702 may be generated automatically for certain time periods and include specific child summaries or they may be generated on an ad hoc basis by designating the time period to summarize and the child summaries 702 to be included.

These summaries are generally used for reporting purposes. They also may be used for running “what-if” scenarios when anticipating organizational changes. Detailed transaction or sub-ledger detail is not provided within the summaries. Apart from the organizational structure validation when running what-if scenarios, there is no budget control or account management function at this level. The hierarchy within the applications of the embodiments of the invention allows the re-organization and the generation of reports on the restructured organization at any time, providing the appropriate hierarchical structure is established and the correct reporting parameters are specified. The embodiments of the system time and date stamp each entered accounting event with the effective date of the event (not necessarily the date entered but may be the date the event occurred). This allows events to be changed, tracked and reported over any time or organizational structure. Typically these summaries are used for building granular hierarchical reporting structures and reporting to outside organizations. A parent segment value may be assigned to various branches of a hierarchy group. This allows drill-down throughout the hierarchy and can be used to reorganize a company by, for example, reassigning children to new parents, etc.

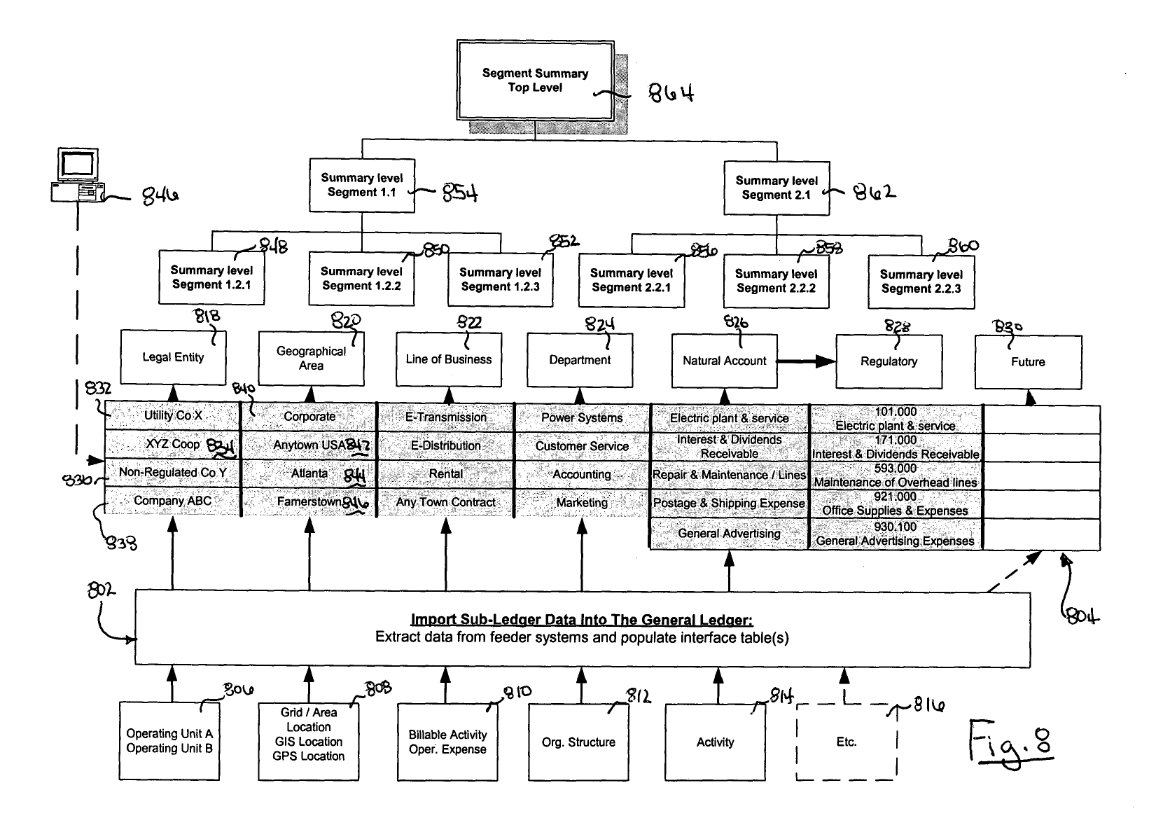

FIG. 8 is a graphical representation of the relationships that exist between sub-ledgers, the general ledger, parents and children of the general ledger, and reporting features of an embodiment of the invention. Information from sub-ledgers that may be furnished as a part of an embodiment of the invention, or may be pre-existing or systems otherwise separate from the invention is used to form interface tables 802 that are in the proper format for importation into the general ledger 804. For example, and as illustrated in FIG. 8, information from sub-ledgers having operating information 806, geographical information 808, billing and expense information 810, organizational structure information 812, activity information 814, and other sub-ledgers 816 is used by an embodiment of the system to create interface tables 802 that are in a format that is readily importable into the general ledger 804.

Accounting events may also be directly entered into the general ledger 804 by a data entry device 846, rather than being imported from an interface table 802 and a sub-ledger.

The general ledger 804 of the embodiment of FIG. 8 is comprised of the exemplary code block segments “Legal Entity” 818, “Geographical Area” 820, “Line of Business” 822, “Department” 824, “Natural Account” 826, “Regulatory” 828 and “Future” 830, which form the chart of accounts for the general ledger 804, although various other code block segments could be used in other embodiments. Each code block segment (except “Future” 830) has child segment values that have been assigned to them. For instance, the code block segment “Legal Entity” 818 has the child segment values that include “Utility Co. X” 832, “XYZ Co-Op” 834, “Non-Regulated Co. Y” 836, “Company ABC” 838, etc., among others. Code block segment “Geographical Area” 820 has child segment values “Corporate” 840, “Anytown USA” 842, “Atlanta” 844, “Farmerstown” 846, etc. among others. Likewise, code block segments “Line of Business” 822, “Department” 824, “Natural Account” 826, and “Regulatory” 828 have been assigned exemplary child segment values, as shown in the embodiment of FIG. 8.

Each accounting event that is entered into an embodiment of the system of the invention, is thus associated with a child segment value of each code block segment so that the event may be properly reported by the chart of accounts of the general ledger 804. As previously described, some child segment values of certain code block segments may be determined by the child segment value of one or more other code block segments that have been assigned to an accounting event so that the data entry person may not have to enter a value for every code block segment that comprises an accounting event.

Each child segment value is a summary point for reporting purposes. For example, a summary can be made of all events that have a value for the code block segment “Legal Entity” 818 of “XYZ Co-Op” 834. Likewise, summaries may be made for the child segments values “Company ABC” 838, “Anytown USA” 842, “Farmerstown” 846, etc. In many instances, however, a summary of more detail than simply all accounting events having a particular child segment value is needed. For example, a summary may be compiled that is comprised of all accounting events that have a “Legal Entity” 818 of “Utility Co. X” 832, a “Geographical Area” 820 of “Atlanta” 844, a “Line of Business” 822 of “Electric Distribution”, a “Department” 824 of “Power Systems” and a “Natural Account” 826 of “Repair and Maintenance/Lines.”Because each “Natural Account” 826 can belong to no more than one “Regulatory Account” 828, but each “Regulatory Account” 828 may be comprised of more than one “Natural Account” 826, the “Regulatory Account” 828 for this summary can be determined without having to explicitly enter the “Regulatory Account” 828 child segment value (i.e., it may be determined from the Natural Account 826). Likewise, as another example, a summary comprised of a “Legal Entity” 818 with a child segment value of “Company ABC” 838, a “Geographical Area” 820 with the child segment value of “Corporate” 840, a “Line of Business” 822 with the child segment value of “Rental”, a “Department” 824 of “Marketing” and a “Natural Account” 826 of “General Advertising” may provide a summary of, for example, billboard rental expenses in the corporate service area for the Company ABC 838. Also, because each “Natural Account” 826 child segment value belongs to one “Regulatory Account” 828, (although each “Regulatory Account” 828 may be comprised of more than one “Natural Account” 826), the “Regulatory Account” 828 does not have to be specified for this summary. However, conversely, rather than specify the “Natural Account” 826, a person could specify a child segment value for a “Regulatory Account” 828 and a summary of the “Regulatory Account” 828 with the specified child segment value will be prepared, so long as the child segment values of all the other code block segments meet their specified values. This summary by a child segment value of the “Regulatory Account” 828 will include all “Natural Accounts” 826 that comprise that chosen child segment value of the “Regulatory Account” 828.

So, referring to FIG. 8, there is no horizontal relationship between child segment values for different code block segments, except between “Natural Account” 826 and “Regulatory Account” 828, because as previously discussed, each “Regulatory Account” 828 child segment value is comprised of at least one “Natural Account” 826 child segment value, and each “Natural Account” 826 child segment value is comprised of no more than one “Regulatory Account” 828 child segment value.

This ability to “pick and choose” child segment values allows the creation of many hierarchies of summaries. For example, Summary Level Segment 1.2.1 848 may be comprised of accounting events for “Utility Co. X” 832 in the “Geographical Area” 820 of “Corporate” 840 with a “Line of Business” 822 of “Electric Distribution”, a “Department” 824 of “Power Systems” and with a “Natural Account” 826 of “Electric Plant and Service” (that correlates to the “Regulatory Account” 828 of “101.0000 Electric Plant & Service”). Summary Level Segment 1.2.2 850 may be comprised of accounting events for “Utility Co. X” 832 in the “Geographical Area” 820 of “Anytown USA” 842, and with the same “Line of Business” 822, “Department” 824, and “Natural Account” 826 as were specified for Summary Level Segment 1.2.1 848. Finally Summary Level Segment 1.2.3 852 may be comprised of accounting events for “Utility Co. X” 832 in the “Geographical Area” 820 of “Atlanta” 844, and with the same “Line of Business” 822, “Department” 824, and “Natural Account” 826 as were specified for Summary Level Segment 1.2.1 848. These three segments (Summary Level Segment 1.2.1 848, Summary Level Segment 1.2.2 850, and Summary Level Segment 1.2.3 852, may then be summarized to form Summary Level Segment 1.1 854. Summary Level Segment 1.1 854, therefore, is a summary comprised of the accounting events of “Utility Co. X” 832 in the “Geographical Areas” 820 of “Corporate” 840, “Anytown USA” 842, and “Atlanta” 844, with a “Line of Business” 822 of “Electric Distribution”, a “Department” 824 of “Power Systems” and with a “Natural Account” 826 of “Electric Plant and Service” (that correlates to the “Regulatory Account” 828 of “101.0000 Electric Plant & Service”).

Similarly, for example, Summary Level Segment 2.2.1 856 may be comprised of accounting events for “Utility Co. X” 832 in the “Geographical Area” 820 of “Corporate” 840 with a “Line of Business” 822 of “Electric Transmission”, a “Department” 824 of “Power Systems” and with a “Natural Account” 826 of “Electric Plant and Service” (that correlates to the “Regulatory Account” 828 of “101.0000 Electric Plant & Service”). Summary Level Segment 2.2.2 858 may be comprised of accounting events for “Utility Co. X” 832 in the “Geographical Area” 820 of “Anytown USA” 842, and with the same “Line of Business” 822, “Department” 824, and “Natural Account” 826 as were specified for Summary Level Segment 2.2.1 856. Finally, Summary Level Segment 2.2.3 860 may be comprised of accounting events for “Utility Co. X” 832 in the “Geographical Area” 820 of “Atlanta” 844, and with the same “Line of Business” 822, “Department” 824, and “Natural Account” 826 as were specified for Summary Level Segment 2.2.1 856. These three segments (Summary Level Segment 2.2.1 856, Summary Level Segment 2.2.2 858, and Summary Level Segment 2.2.3 860, may then be summarized to form Summary Level Segment 2.1 862. Summary Level Segment 2.1 862, therefore, is a summary comprised of the accounting events of “Utility Co. X” 832 in the “Geographical Areas” 820 of “Corporate” 840, “Anytown USA” 842, and “Atlanta” 844, with a “Line of Business” 822 of “Electric Transmission”, a “Department” 824 of “Power Systems” and with a “Natural Account” 826 of “Electric Plant and Service” (that correlates to the “Regulatory Account” 828 of “101.0000 Electric Plant & Service”).

Finally, for example, a top level summary 864 may be prepared by summarizing Summary Level Segment 1.1 854 and Summary Level Segment 2.1 862. This top level summary will provide a summary comprised of the accounting events of “Utility Co. X” 832 in the “Geographical Areas” 820 of “Corporate” 840, “Anytown USA” 842, and “Atlanta” 844, with the “Lines of Business” 822 of “Electric Distribution” and “Electric Transmission”, a “Department” 824 of “Power Systems” and with a “Natural Account” 826 of “Electric Plant and Service” (that correlates to the “Regulatory Account” 828 of “101.0000 Electric Plant & Service”).

Likewise, various other hierarchical summary structures may be developed that are comprised of various child segment values of the code block segments and summaries of these first level summaries may be made so long as the summary has meaning to a user.

Although generally described for utility applications, the concepts of this invention are equally applicable to non-utility entities that are required or that desire to create various accounting reports from single ledger entries for each accounting event. Furthermore, embodiments of the invention to accounting functions whereby accounting events are associated with a minimized chart of accounts and are posted to a general ledger with the chart of accounts forming the basis for the general ledger.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

1. A system for providing at least two of financial, managerial and government compliant regulatory reports from entries into a general ledger for an organization comprised of more than one functional area, each entry into the general ledger describing a discrete accounting event, the system comprised of:
an input device for receiving entries into the general ledger with each entry comprised of a certain number of segments that form an account flexfield and each segment having a respective alphanumeric length and with each segment describing a characteristic of the discrete accounting event, wherein the account flexfield is used for each entry into the general ledger for all the functional areas;
a processing device for executing a set of software instruction to form the at least two of financial, managerial and government compliant regulatory reports from the entries into the general ledger according to the set of software instructions; and
an output device for viewing the at least two of financial, managerial and government compliant regulatory reports.

2. The system of claim 1, wherein the input device for receiving entries into the general ledger receives an entry comprised of seven segments to form the account flexfield.

3. The system of claim 2, wherein the seven segments are company, line of business, geography, department, natural account, regulatory account, and future use.

4. The system of claim 3, wherein the segments company, line of business, geography, department, natural account and future use are entered into the input device and the regulatory account segment is determined by the set of software instructions from the segments that were entered.

5. The system of claim 3, wherein the segments company, line of business, geography, department, regulatory account and future use are entered into the input device and the natural account segment is determined by the set of software instructions from the segments that were entered.

6. The system of claim 2, wherein six segments are entered into the input device and the other segment is determined by the set of software instructions based upon the six segments that were entered.

7. The system of claim 1, wherein the input device for receiving entries into the general ledger receives the account flexfield at one level of detail and the processing device executes a set of software instruction to form the at least two of financial, managerial and government compliant regulatory reports from the entries into the general ledger according to the set of software instructions and the account flexfield is reported at a second level of detail, wherein the first level of detail and the second level of detail are not the same.

8. The system of claim 7, wherein the account flexfield is entered at the activity level and reported at least one of the natural account, regulatory account and work order level.

9. The system of claim 7, wherein the account flexfield is entered at the natural account level and reported at least one of the activity, regulatory account and work order level.

10. The system of claim 7, wherein the account flexfield is entered at the regulatory account level and reported at least one of the activity, natural account and work order level.

11. The system of claim 7, wherein the account flexfield is entered at the work order level and reported at least one of the activity, natural account and regulatory account level.

12. A software system that integrates accounting, materials management, work management and regulatory reporting functions within a government regulated organization, where such software system is comprised of:
an entry device for receiving ledger entries for accounting events, the accounting, materials management, work management and regulatory reporting functions driven by the ledger entries for accounting events;
a memory device for electronically storing a set of software instructions and a general ledger, wherein the ledger entries for accounting events are stored in the general ledger and the ledger entries for accounting events are in a common form that is comprised of a defined number of segments that form a chart of accounts for the general ledger;
a processing device for processing the set of software instructions wherein the ledger entries are received into the general ledger at a first level of detail and the set of software instructions are capable of providing a reporting function on such accounting events in one or more formats suitable for one or more of regulatory reports and financial and managerial accounting reports at a second level of detail, the first level of detail and the second level of detail not being the same; and
an output device for viewing the one or more of the regulatory reports and financial and managerial accounting reports.

13. The software system of claim 12, wherein the memory device electronically stores a general ledger with the chart of accounts comprised of seven segments.

14. The software system of claim 13, wherein the seven segments are company, line of business, geography, department, natural account, regulatory account, and future use.

15. The software system of claim 14, wherein the segments company, line of business, geography, department, natural account and future use are entered into the input device and the regulatory account segment is determined by the set of software instructions from the segments that were entered.

16. The software system of claim 14, wherein the segments company, line of business, geography, department, regulatory account and future use are entered into the input device and the natural account segment is determined by the set of software instructions from the segments that were entered.

17. The software system of claim 13, wherein six segments are entered into the input device and the other segment is determined by the set of software instructions from the six segments that were entered.

18. The software system of claim 12, wherein the ledger entries are entered at the activity level and reported at least one of the natural account, regulatory account and work order level.

19. The software system of claim 12, wherein the ledger entries are entered at the natural account level and reported at least one of the activity, regulatory account and work order level.

20. The software system of claim 12, wherein the ledger entries are entered at the regulatory account level and reported at least one of the activity, natural account and work order level.

21. The software system of claim 12, wherein the ledger entries are entered at the work order level and reported at least one of the activity, natural account and regulatory account level.

22. A method for providing at least two of financial, managerial and government compliant regulatory reports, comprising:
entering an account flexfield into a general ledger for an organization via an input device, each account flexfield describing a discrete accounting event, the account flexfield comprised of a certain number of segments of a respective alphanumeric length that form the account flexfield and with each segment describing a characteristic of the discrete accounting event at a first level of detail;
processing the account flexfield according to a set of software instructions residing on one or more processors to form the at least two of financial, managerial and government compliant regulatory reports at a second level of detail with the first level of detail being different from the second level of detail; and
sending the at least two of financial, managerial and government compliant regulatory reports to an output device where they may be viewed.

23. The method of claim 22, wherein the first level of detail is one chosen from the group consisting of activity, work order, natural account or regulatory account; and the second level of detail is one chosen from the group consisting of work order, natural account or regulatory account

24. The method of claim 22, wherein the account flexfield is comprised of no more than seven segments.

25. The method of claim 24, wherein the segments are company, line of business, geography, department, natural account, and regulatory account.

26. The method of claim 25, wherein the segments company, line of business, geography, department, and natural account are entered into the input device and the regulatory account segment is determined by the set of software instructions from the segments that were entered.

27. The method of claim 25, wherein the segments company, line of business, geography, department, and regulatory account are entered into the input device and the natural account segment is determined by the set of software instructions from the segments that were entered.

28. The method of claim 24, wherein at least five of the segments of the account flexfield are known when entering the segments into the input device and one or more other segments are determined by the set of software instructions from the segments that were entered.

29. The method of claim 22, wherein the account flexfield is entered at the activity level and is reported at least one of the levels of natural account, regulatory account and work order.

30. The method of claim 22, wherein the account flexfield is entered at the natural account level and is reported at least one of the levels of activity, regulatory account and work order.

31. The method of claim 22, wherein the account flexfield is entered at the regulatory account level and is reported at least one of the levels of activity, natural account and work order.

32. The method of claim 22, wherein the account flexfield is entered at the work order level and is reported at least one of the levels of activity, natural account and regulatory account.

33. A method of associating discrete accounting events with a limited number of code segments, wherein the code segments form a chart of accounts for a general ledger and the code segments allow each accounting event to be reported at a regulatory account, a natural account and an activity level.
